(19) United States
(12) Patent Application Publication
(10) Pub. No.: US 2025/0019789 A1
(43) Pub. Date: Jan. 16, 2025

(54) METHOD FOR MANUFACTURING A DOUBLE-LAYERED HEAT EXCHANGE WALL

(71) Applicant: COMMISSARIAT A L'ENERGIE ATOMIQUE ET AUX ENERGIES ALTERNATIVES, Paris (FR)

(72) Inventor: Denis SORNIN, Saint Pierre Du Perray (FR)

(73) Assignee: COMMISSARIAT A L'ENERGIE ATOMIQUE ET AUX ENERGIES ALTERNATIVES, Paris (FR)

(21) Appl. No.: 18/713,458

(22) PCT Filed: Nov. 30, 2022
(86) PCT No.: PCT/FR2022/052198

§ 371 Date: May 24, 2024

(30) Foreign Application Priority Data
Dec. 2, 2021 (FR) FR2112871

(51) Int. Cl. C21D 9/50; B23K 9/025; C21D 6/00; C21D 9/46

(52) U.S. Cl. CPC C21D 9/50; B23K 9/025; C21D 6/00; C21D 9/46; C21D 2251/04

(57) ABSTRACT

A method for manufacturing a double-layer heat-exchange wall including first and second metal layers includes the following successive steps: (i) providing a first metal sheet forming the first layer, a second metal sheet forming the second layer, and a leaf of iron Fe⁰ having a thickness of between 10 μm and 100 μm; (ii) assembling the first and second metal sheets and the leaf of iron Fe⁰, the leaf interposed between the first and second metal sheets; (iii) mechanical pressing of the assembly at a minimum pressure of 1 MPa; (iv) peripheral welding of the pressed assembly; and (v) heat treatment of the welded assembly, the heat treatment being implemented by hot isostatic pressing conducted at a temperature of between 800° C. and 1200° C., at a pressure of between 10⁸ Pa and 2.10⁸ Pa, for a period of between 1 hour and 3 hours.

### TECHNICAL FIELD

The present invention relates to a method for manufacturing a double-layer heat-exchange wall, this double-layer wall being in particular intended to equip devices of the heat exchanger type.

Such heat exchangers find an application in the chemical industry or in the energy field.

### PRIOR ART

Heat exchangers are devices for transferring thermal energy from a first fluid to a second fluid, without mixing them.

Various types of dual-fluid heat exchangers exist, including those that are equipped with a so-called “double layer” heat-exchange wall that comprises two layers that are of different or identical thicknesses and are intended to come into contact each with one of the heat-transfer fluids.

The particular structure of the double-layer wall has the advantage of conferring enhanced safety to the heat exchanger fitted with it, since each layer ensures, in a redundant manner, a dual function, namely the fluid tightness function to avoid contact between the two heat-transfer fluids and the function to withstand the pressure of the heat-transfer fluids.

This dual function is particularly important, for example, in the case where the heat exchanger equips plant, such as chemical reactors, in which it is necessary to provide, safely and effectively, the exchange of heat between a first fluid such as reactive molten metals or metal salts, for example based on sodium, lithium or potassium, and a second fluid such as water. This is because any failure of the heat-exchange wall equipping such plant would have serious consequences for the operation due to the chemical reactivity of the heat-transfer medium with the medium to be cooled. In this specific case, the strains in service, in addition to the static pressure of the fluids and to the corrosion of the surfaces, result from stresses of thermal origin and fatigue strains imposed by the operating cycles or the vibrations caused by the thermohydraulic system.

The majority of double-layer heat-exchange walls envisage leaving a mechanical clearance, or gap, between the two layers.

By connecting this gap to a detection system, it then becomes possible to detect the presence of fluid coming from the piercing of one of the two layers before the integrity of the second is impaired.

However, the presence of this gap is particularly detrimental with regard to the thermal conductivity properties of the heat-exchange wall and furthermore does not make it possible to effectively respond to a hypothetical simultaneous piercing of the first layer and of the second layer forming it.

To improve the thermal conductivity of double-layer heat-exchange walls, it has been proposed to at least partially fill the gap existing between the first layer and the second layer.

Thus, document US 2013/0205861, referenced [1] in the remainder of the present description, proposes a method for manufacturing a heat-exchange wall formed by a double-layer tube in which, after a step of polishing the internal surface of the external tube and the external surface of the internal tube, braided wires are interposed in the gap formed by the external and internal tubes and then drawing and heat treatment are implemented.

Document CN 203928838, referenced [2], proposes a method for manufacturing a heat-exchange wall also formed by a double-layer tube that comprises a step consisting in filling the gap between the internal and external tubes with a metal powder. By providing a radial distribution of the temperature, this metal powder confers good thermal conductivity to the double-layer tube and also makes it possible to attenuate the risks of degradation linked to sudden thermal transitions.

Document US 2013/070889, referenced [3], proposes a method for manufacturing a double-layer tube implementing a step of cold machining of an assembly formed by an internal tube inserted inside an external tube in which:
either the external tube, which is made from ferritic steel with at least 2% by mass of chromium, comprises, on its internal surface, a layer of oxide scale containing chromium with a thickness of between 10 μm and 30 μm, and the internal tube, which is made from steel or from an alloy with at least 2% by mass of chromium, comprises, on its external surface, which is machined and/or ground over a thickness of at least 0.1 mm, a layer of scale,
or the internal tube, which is made from ferritic steel with at least 2% by mass of chromium, comprises, on its external surface, a layer of oxide scale containing chromium with a thickness of between 10 μm and 30 μm, and the external tube, which is made from steel or from an alloy with at least 2% by mass of chromium, comprises, on its internal surface, which is machined and/or ground over a thickness of at least 0.1 mm, a layer of scale.

The cold-machining step implemented in the method of document [3] is implemented so as to achieve a reduction rate of 5% to 30% of the external thickness.

Document GB 2 241 339, referenced [4], also proposes a method for manufacturing a heat-exchange wall comprising three concentric metal tubes that are in close contact, at their interfaces, so as to ensure good thermal contact between the three tubes. This close contact can be obtained by brazing or welding. In document [4], the intermediate tube can be made from a material based on iron or on steel and the interior and exterior tubes can be made from copper or from a copper alloy.

Although they improve the thermal-conductivity properties of the double-layer tubes, the manufacturing method described in documents [1] to [4] have thermal conductivities that are too detrimental for the intended operation.

The aim of the present invention is consequently to propose a method for manufacturing a double-layer heat-exchange wall that has the dual function of fluidtightness and resistance to the pressure of the heat-transfer fluids, in particular by resisting the propagation of fatigue defects, this double-layer exchange wall then offering a maximum guarantee of integrity in service fora minimum penalty in thermal conductivity.

### DESCRIPTION OF THE INVENTION

The previously stated aim, as well as others, are achieved by a method for manufacturing a double-layer heat-exchange wall comprising a first layer and a second layer, the first and second layers being metallic.

According to the invention, the manufacturing method comprises the following successive steps (i) to (v), and optionally (vi),
(i) the provision:
   of a first metal sheet intended to form the first layer and having a thickness e₁,
   of a second metal sheet intended to form the second layer and having a thickness e₂, and
   of a leaf of iron Fe⁰ having a thickness e₃ of between 10 μm and 100 μm and, advantageously, between 50 μm and 100 μm;
(ii) the assembly of the first and second metal sheets and the leaf of iron Fe⁰, the leaf being interposed between the first and second metal sheets,
(iii) the mechanical pressing of the assembly obtained at the end of the previous step at a minimum pressure of 1 MPa;
(iv) the peripheral welding of the pressed assembly obtained at the end of step (iii);
(v) the heat treatment of the welded assembly obtained at the end of step (iv), this heat treatment being implemented by hot isostatic pressing conducted at a temperature of between 800° C. and 1200° C., at a pressure of between 10⁸ Pa and 2.10⁸ Pa, for a period of between 1 hour and 3 hours;
and, optionally,
(vi) a supplementary treatment such as curving, bending, quenching, normalised ageing or annealing.

The method according to the invention makes it possible to form, between the first and second layers, a metallic interphase made from pure iron. This interphase, which is ductile and dense and fills the entire initial volume of the gap existing between the first and second metal sheets, thus makes it possible to ensure a uniform mechanical junction between the first and second layers. The absence of clearance between these first and second layers makes it possible to avoid the movement of these two layers with respect to each other: as these two layers now form only a single wall, they then deform in the same manner as a monolithic wall during subsequent mechanical stress or shaping. Thanks to the manufacturing method according to the invention, we obtain a double-layer wall with a geometric quality that does not require calibration after the heat treatment step by hot isostatic pressing.

The metallic interphase made from pure iron also makes it possible to give the double-layer wall excellent thermal conductivity properties by ensuring very good heat transfer between the first and second layers, which has the effect of increasing the efficiency of a heat exchanger equipped with such a double-layer wall. Unexpectedly and surprisingly, the Inventors found that this dense ductile interphase made from iron Fe⁰ provides thermal conductivity that is greater than or equal to 80% of the thermal conductivity of an equivalent solid wall, or even greater than 95% in the particular case of the use of the leaf of iron Fe⁰.

This ductility of the metal iron interphase also makes it possible to deflect and/or to stop the propagation of any fatigue cracks, in particular of fatigue cracks after a large number of cycles, which might be formed and propagated within one of the two layers, thus preserving the integrity of the other layer. In particular, when fatigue cracks are deflected, they propagate in the ductile metal interphase, thus offering a service life extended by 30% at room temperature.

This iron interphase is furthermore characterised by impermeability enabling it to avoid the capillary propagation of fluid coming from such a crack between the two layers.

The method according to the invention makes it possible to manufacture a double-layer wall having a thickness eₜₒₜ.

The method according to the invention comprises steps (i) to (v), and optionally (vi), mentioned above and detailed below.

During step (i) of the manufacturing method according to the invention, two metal sheets are provided, a first metal sheet that is intended to form the first layer of the double-layer wall, and a second metal sheet that is intended to form the second layer of this same double-layer wall.

The first metal sheet has a thickness denoted e₁, while the second metal sheet has a thickness denoted e₂.

According to one embodiment, the thickness e of the first metal sheet and the thickness e₂ of the second metal sheet are each between 1 mm and 30 mm, advantageously between 1 mm and 5 mm, and preferentially between 1 mm and 2 mm. However, although lying in identical intervals of values, the thicknesses e₁ and e₂ of the first and second metal sheets are not necessarily identical.

The expression “between . . . and . . . ” that is used above but also in the remainder of the present description to define an interval must be understood as defining not only the values of the interval but also the values of the bounds of this interval.

During step (i) of the manufacturing method according to the invention, a leaf which consist of iron with an oxidation state of 0, i.e. pure iron Fe⁰, is also provided.

This leaf of iron Fe⁰ has a thickness, denoted e₃, that is between 10 μm and 100 μm and, advantageously, between 50 μm and 100 μm.

The manufacturing method according to the invention comprises, after step (i), a step (ii) of assembling the first and second metal sheets and the leaf of iron Fe⁰, the leaf being interposed between the first and second metal sheets.

In other words, at the end of step (ii), an assembly, in which the leaf of iron Fe⁰ is sandwiched between the first and second metal sheets, is obtained.

In a variant implementation of the manufacturing method according to the invention, steps (i) and (ii) that have just been described can be replaced respectively by the following steps (i′) and (ii′):
(i′) the provision:
   of a first metal sheet intended to form the first layer and having a thickness e₁, and
   of a second metal sheet intended to form the second layer and having a thickness e₂, this second metal sheet comprising, on one of its surfaces, a coating of iron Fe⁰; and
(ii′) the assembly of the first metal sheet and of the coated second metal sheet, the coating of iron Fe⁰ being placed between the first and second metal sheets.

During step (i′) of this variant of the manufacturing method according to the invention, two metal sheets are provided, a first metal sheet that is intended to form the first layer of the double-layer wall, and a second metal sheet that is intended to form the second layer of this same double-layer wall.

As before, the first metal sheet has a thickness denoted e₁, while the second metal sheet has a thickness denoted e₂.

According to one embodiment, the thickness e of the first metal sheet and the thickness e₂ of the second metal sheet are each between 1 mm and 30 mm, advantageously between 1 mm and 5 mm, and preferentially between 1 mm and 2 mm. As already indicated previously, although lying in identical intervals of values, the thicknesses e₁ and e₂ of the first and second metal sheets are not necessarily identical.

In this variant, the second metal sheet comprises, on one of its surfaces, a coating of iron with an oxidation state of 0, i.e. of pure iron Fe⁰.

This coating of iron Fe⁰ has a thickness, denoted e₃, that is between 10 μm and 100 μm and, advantageously, between 50 μm and 100 μm.

In other words, the coated second sheet has a thickness, denoted e_{2′}, such that e_{2′}=e₂+e₃.

According to an embodiment of this variant of the manufacturing method according to the invention, the coating of iron Fe⁰ is obtained by cold spraying of iron powder Fe⁰ onto one of the surfaces of the second metal sheet.

In this variant, the manufacturing method according to the invention comprises, after step (i′), a step (ii′) of assembling the first metal sheet and the coated second metal sheet, the coating of iron Fe⁰ being placed between the first and second metal sheets.

In other words, at the end of step (ii′), an assembly, in which the leaf of iron Fe⁰ is positioned between the first and second metal sheets, is obtained.

The choice of using a leaf of iron Fe⁰ with a thickness of 10 μm to 100 μm, just like the choice of producing, by cold spraying, a coating of iron Fe⁰ with a thickness of 10 μm to 100 μm, makes it possible to create, between the first and second layers, a ductile interphase of iron Fe⁰. This ductile Interphase of iron Fe⁰ makes it possible to significantly slow down and deflect the speed of propagation of any fatigue cracks that might be formed within one of these two layers and, consequently, to increase by up to 30% the service life under fatigue of the other (undamaged) layer and, therefore, of the double-layer wall manufactured by the method according to the invention.

As will be seen in the following examples, the choice will advantageously relate to the production of the iron interphase using the interposing of a leaf of iron Fe⁰, which makes it possible to obtain a double-layer wall having mechanical and thermal-conductivity properties that are superior to those of a double-layer wall in which the iron interphase is obtained by cold spraying of iron powder Fe⁰.

In an advantageous variant, the method according to the invention further comprises a step of cleaning the surfaces of the first metal sheet and the surfaces of the second metal sheet or of the coated second sheet, this cleaning step being implemented prior to the assembly step (ii) or (ii′).

In another advantageous variant, the method according to the invention further comprises a step of grinding the first metal sheet and the second metal sheet, optionally coated, this grinding step being implemented prior to the assembly step (ii) or (ii′).

The manufacturing method according to the invention comprises, after the assembly step (ii) or (ii′), a step (iii) of mechanical pressing of the assembly obtained at the end of step (ii) or (ii′), this mechanical pressing be implemented at a minimum pressure of 1 MPa.

The choice of such a mechanical pressing step (iii) has the advantage of further reducing the volume of the gap existing between the first metal sheet and the second metal sheet, optionally coated. In doing so, the quantity of gas contained between these two metal sheets becomes negligible.

The manufacturing method according to the invention comprises, after the mechanical pressing step (iii), a step (iv) of peripheral welding of the assembly as obtained at the end of step (iii). In doing so, a welding of the periphery of the first and second metal sheets is obtained.

This welding step (iv), which may be implemented by means of any welding technique making it possible to obtain a gastight weld, makes it possible to isolate the interphase of iron Fe⁰ interposed between the first and second metal sheets.

The welding step (iv) can in particular be implemented by laser, by rod, by electron beam or, and advantageously, by an arc welding method with a non-meltable electrode, where appropriate in the presence of a filler metal. The latter type of welding can in particular be implemented by TIG welding (TIG being the acronym for “Tungsten Inert Gas”) without filler metal.

The presence of the interphase of iron Fe⁰ makes it possible not to affect the composition of the welded joints nor the composition of the first and second metal sheets, which therefore keep their mechanical properties. This choice of interphase of iron Fe⁰ consequently makes it possible to provide an assembly, by means of reliable welding, of the double-layer walls manufactured by the method according to the invention with the structures of a device that they are intended to equip, for example with those of a heat exchanger. This is because, since the iron Fe⁰ of the interphase only marginally modifies the composition of the peripheral weld, the interphase consequently does not alter the mechanical properties of this peripheral weld thus produced.

The manufacturing method according to the invention comprises, at the end of the welding step (iv), a step (v) of heat treatment of the welded assembly as obtained at the end of step (iv).

This heat treatment step (v) is implemented by hot isostatic pressing (HIP) conducted at a temperature of between 800° C. and 1200° C., at a pressure of between 10⁸ Pa and 2.10⁸ Pa, for a period of between 1 hour and 3 hours.

This step (v) of hot isostatic pressing makes it possible to weld, by diffusion, the first metal sheet and the second metal sheet, optionally coated, and, in doing so, to obtain a uniform mechanical junction between these first and second metal sheets. At the end of the hot isostatic pressing step (v), this uniform mechanical junction is formed by the interphase of iron Fe.

In an advantageous variant, the method according to the invention further comprises at least one step of grinding the assembly, this or these grinding steps being implemented prior to the welding step (iv) and/or prior to the heat treatment step (v).

In a particularly advantageous variant, the method according to the invention does not comprise a degassing step between the mechanical pressing step (iii) and the welding step (iv), and/or does not comprise a degassing step between the welding step (iv) and the heat treatment step (v).

The eliminating of one or two degassing steps, which are particularly complex to implement on an industrial level in the context of the manufacture of double-layer walls, contributes to a significant reduction of cycle times, costs and production times.

The method according to the invention makes it possible to manufacture double-layer walls with variable lengths and geometries.

The materials of the first tube and of the second tube (without coating) may be identical or different. These materials may in particular comprise iron.

In an advantageous variant, the first and second metal sheets are produced from a material comprising iron, this material being advantageously selected from iron Fe⁰ and a steel, for example martensitic steel such as Eurofer-97.

In a preferred variant, the materials of the first and second metal sheets are identical.

In a variant, the method according to the invention further comprises at least one supplementary treatment step (vi). The purpose of such a supplementary treatment (vi) is in particular to confer a specific form and/or particular mechanical properties to the double-layer wall manufactured by the method according to the invention.

This supplementary treatment (vi) can, for example, be selected from curving, bending, quenching, normalised ageing and annealing, or even be a combination of supplementary treatments (quenching followed by normalised ageing).

By means of such a supplementary treatment (vi), the double-layer wall can, for example, be conformed as a tube with a circular, square or rectangular cross-section.

The invention will be understood better in the light of the additional description which follows and which refers to the accompanying FIGS. 1 and 2.

This additional description is given only by way of illustration of the object of the invention and must under no circumstances be interpreted as a limitation of this object.

### BRIEF DESCRIPTION OF THE DRAWINGS

FIG. 1 illustrates the evolution of the progression of a fatigue crack (denoted a and expressed in mm), at ambient temperature, as a function of the number of cycles (denoted N) of two double-layer walls in accordance with the invention (denoted RS and CS) and of a reference similar solid wall (denoted Massive).

FIG. 2 illustrates the evolution of the equivalent thermal conductivity (denoted λ and expressed in W/m·K) as a function of temperature (denoted T and expressed in K) of two double-layer walls in accordance with the invention (denoted RS and CS) and of a reference similar solid wall (denoted Massive).

### DETAILED DESCRIPTION OF PARTICULAR EMBODIMENTS

1. Manufacture of double-layer walls by the method according to the invention and of a reference wall

1.1. A first double-layer wall, denoted RS, was manufactured by the method according to the invention.

Rolling of two metal sheets made from Eurofer-97 was implemented so as to confer thereon a thickness of 6.00 mm (+0.0/−0.1 mm) for the first metal sheet and a thickness of 4 mm (+0.0/−0.1 mm) for the second metal sheet.

Rolling of a sheet of metallic iron Fe⁰ was implemented until a leaf having a thickness of 100 μm was obtained.

After grinding and then cleaning of the surfaces of the two metal sheets, the two metal sheets and the leaf were assembled in a sandwich by interposing this leaf of metallic iron between the first and second metal sheets.

The mechanical pressing of the assembly was then implemented by exerting a pressure of 1 MPa by means of a press and then peripheral welding by TIG was implemented over the entire periphery of the assembly.

The assembly thus welded was then subjected to heat treatment by implementing a hot isostatic pressing (HIP) cycle conducted at a temperature of 1100° C. and at a pressure of 1200 bar (1.2×10⁸ Pa) for 1 hour, and then to supplementary heat treatments of quenching after maintaining a temperature of 980° C. for 30 minutes and of ageing at 760° C. for 90 minutes.

At the end of these heat treatments, the double-layer wall RS is obtained.

1.2. A second double-layer wall, denoted CS, was manufactured by the method according to the invention.

Rolling of two metal sheets made from Eurofer-97 was implemented so as to confer thereon a thickness of 6.00 mm (+0.0/−0.1 mm) for the first metal sheet and a thickness of 4 mm (+0.0/−0.1 mm) for the second metal sheet.

A deposition by cold spraying of a metallic iron powder was then implemented on one of the surfaces of the second metal sheet so as to form a coating of iron with a thickness of more than 100 μm.

After grinding of the deposit to a thickness of 100 μm and then cleaning of the surfaces of the two metal sheets, assembly of the first metal sheet and of the coated second metal sheet was implemented, the coating of metallic iron being positioned between the first and second metal sheets.

The assembly thus obtained was next subjected to the steps of mechanical pressing, welding, heat treatment by HIC and supplementary heat treatments described in part 1.1. above.

At the end of these heat treatments, the double-layer wall CS is obtained.

1.3. A reference wall, denoted Massive, was also produced.

Rolling of a metal sheet made from Eurofer-97 was implemented so as to confer thereon a thickness of 10.00 mm (+0.0/−0.1 mm).

The metal sheet was next subjected to the steps of heat treatment by HIC and supplementary heat treatments described in part 1.1. above.

At the end of these heat treatments, the reference wall Massive is obtained.

### 2. Characterisation of the Double-Layer Walls RS and CS and of the Reference Wall Massive

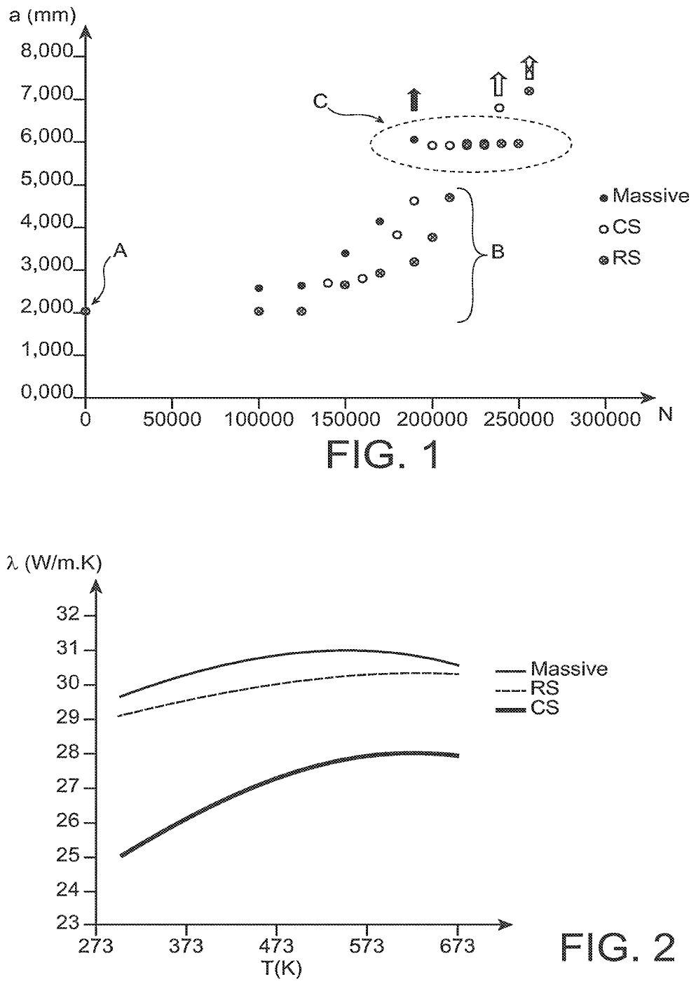

2.1. Bending test pieces of 10×10×55 mm were taken from each of the walls RS, CS and Massive. A notch of 2 mm, marked by the point A on FIG. 1, was formed in each of the test pieces, respectively denoted RS, CS and Massive, to allow the initiation of a fatigue crack during fatigue loading.

The propagation of this notch was next examined by subjecting the test pieces to cycles of three-point bending stresses at constant maximum force of 60% of the yield strength of the material of the metal sheets. A minimum force of 150 N is maintained in order not to detach the tool from the test piece. The path of the crack is followed in situ by image correlation.

With reference to the zone marked B in FIG. 1, it is observed that the test pieces RS and CS according to the invention are characterised by a delayed propagation of the crack compared with that of the reference test pieces Massive.

With reference to the zone marked C in FIG. 1, it is also noted that the test pieces RS and CS according to the invention exhibit a stagnation of the length of the crack at the interphase (propagation distance of 6 mm). This leads to an increase in the service life of the double-layer walls RS and CS compared with that of the reference wall Massive.

These results clearly show that selecting a ductile interphase of Fe⁰ makes it possible to significantly modify the crack propagation speed and to significantly increase the service life under fatigue at ambient temperature of the undamaged layer.

2.2. The thermal conductivity of each of the test pieces RS, CS and Massive was measured.

Referring to the results illustrated on FIG. 2, it is observed that the test pieces RS and CS manufactured by the method according to the invention have a thermal conductivity A very close to the reference test piece Massive and that this coefficient of thermal conductivity represents at least 80% of the thermal conductivity of the reference wall Massive for the double-layer wall CS and close to 95% for the double-layer wall RS.

### BIBLIOGRAPHY

[1] US 2013/0205861 A1
[2] CN 203928838 U
[3] US 2013/070889 A1
[4] GB 2 241 339 A

1. A method for manufacturing a double-layer heat-exchange wall comprising a first layer and a second layer, the first and second layers being metallic, this manufacturing method comprising the following successive steps (i) to (v), and optionally (vi):
(i) the provision:
of a first metal sheet intended to form the first layer and having a thickness e₁,
of a second metal sheet intended to form the second layer and having a thickness e₂, and
of a leaf of iron Fe⁰ having a thickness e₃ of between 10 μm and 100 μm and, advantageously, between 50 μm and 100 μm;
(ii) the assembly of the first and second metal sheets and the leaf of iron Fe⁰, the leaf being interposed between the first and second metal sheets,
(iii) the mechanical pressing of the assembly obtained at the end of the previous step at a minimum pressure of 1 MPa;
(iv) the peripheral welding of the pressed assembly obtained at the end of step (iii);
(v) the heat treatment of the welded assembly obtained at the end of step (iv), this heat treatment being implemented by hot isostatic pressing conducted at a temperature of between 800° C. and 1200° C., at a pressure of between 10⁸ Pa and 2.10⁸ Pa, for a period of between 1 hour and 3 hours;
and, optionally,
(vi) a supplementary treatment such as curving, bending, quenching, normalised ageing or annealing.

2. The method according to claim 1, wherein steps (i) and (ii) are respectively replaced by the following steps (i′) and (ii′):
(i′) the provision:
of a first metal sheet intended to form the first layer and having a thickness e₁, and
of a second metal sheet intended to form the second layer and having a thickness e₂, this second metal sheet comprising, on one of its surfaces, a coating of iron Fe⁰, this coating having a thickness e₃ of between 10 μm and 100 μm and, advantageously, between 50 μm and 100 μm, the coated second metal sheet having a thickness e_{2′} such that e_{2′}=e₂+e₃; and
(ii′) the assembly of the first metal sheet and of the coated second metal sheet, the coating of iron Fe⁰ being placed between the first and second metal sheets.

3. The method according to claim 2, wherein the coating of iron Fe⁰ is obtained by cold spraying of iron powder Fe⁰ on one of the surfaces of the second metal sheet.

4. The method according to claim 1, wherein the welding step (iv) is implemented by an arc welding method with a non-meltable electrode, where appropriate in the presence of a filler metal.

5. The method according to claim 1, further comprising a step of cleaning the surfaces of the first metal sheet and the surfaces of the coated second metal sheet, this cleaning step being implemented prior to the assembly step (ii).

6. The method according to claim 1, further comprising a step of grinding the first and second metal sheets, this grinding step being implemented prior to the assembly step (ii).

7. The method according to claim 1, further comprising at least one step of grinding the assembly, this or these grinding steps being implemented prior to the welding step (iv) and/or prior to the heat treatment step (v).

8. The method according to claim 1, which does not comprise a degassing step between the mechanical pressing step (iii) and the welding step (iv) and/or between the welding step (iv) and the heat treatment step (v).

9. The method according to claim 1, wherein the first and second metal sheets are produced from a material comprising iron, this material advantageously being selected from iron Fe⁰ and a steel.

10. The method according to claim 1, wherein the materials of the first and second metal sheets are identical.

11. The method according to claim 1, wherein the thicknesses e₁ and e₂ of the first and second metal sheets are between 1 mm and 30 mm, advantageously between 1 mm and 5 mm, and preferentially between 1 mm and 2 mm.

12. The method according to claim 2, further comprising a step of cleaning the surfaces of the first metal sheet and the surfaces of the coated second metal sheet, this cleaning step being implemented prior to the assembly step (ii′).

13. The method according to claim 2, further comprising a step of grinding the first and second metal sheets, this grinding step being implemented prior to the assembly step (ii′).
